(19) United States
(12) Patent Application Publication
(10) Pub. No.: US 2023/0345926 A1
(43) Pub. Date: Nov. 2, 2023

(54) APPARATUS AND METHOD TO CONTROL PEST INFESTATION OF A MANMADE BEEHIVE

(71) Applicants: Zairiati Zakaria, Birmingham, AL (US); Jerome Longbottom, Birmingham, AL (US)

(72) Inventors: Zairiati Zakaria, Birmingham, AL (US); Jerome Longbottom, Birmingham, AL (US)

(21) Appl. No.: 18/295,546

(22) Filed: Apr. 4, 2023

Related U.S. Application Data
(60) Provisional application No. 63/363,860, filed on Apr. 29, 2022.

(51) Int. Cl. A01K 49/00; A01K 47/06; A01M 1/20

(52) U.S. Cl. CPC A01M 1/2094; A01K 47/06; A01K 49/00; A01M 2200/011

(57) ABSTRACT

A system, method, and apparatus for thermal management of Varroa mite infestations in manmade beehives includes a portable direct current controller that selectively controls power to a heated bottom board that is installed underneath the bottommost brood box of the beehive. The bottom board elevates the temperature within the brood boxes to a constant temperature of approximately 107° F. The bottom board provides an entrance that is movable between a closed condition and an open condition. An adjustable queen excluder is disposed between the uppermost brood box and the honey super box, wherein the queen excluder is moveable between a passage position and an exclusion position preventing passage of the entire honeybee colony between the brood boxes and the honey super boxes. The excluded position prevents leakage of the heat as well as keeps the honey super boxes below the elevated temperature.

### CROSS-REFERENCE TO RELATED APPLICATION

This application claims the benefit of priority of U.S. Provisional Application No. 63/363,860, filed Apr. 29, 2022, the contents of which are herein incorporated by reference.

### BACKGROUND OF THE INVENTION

The present invention relates beekeeping, and more particularly to apparatus and methods to control pest infestation, such as Varroa mite infestation, of manmade beehive.

Varroa mite infestation is the greatest threat to honeybees worldwide. The mites feed off the adult, pupa, and larva of honeybees and are a major factor in colony collapse disorder. Existing thermal management options for killing and controlling the Varroa mite are not user friendly, produce fluctuating, inconsistent beehive temperatures, fail to satisfactorily regulate the movement of the honeybee colony during treatment, and are not an integral part of the manmade beehive.

Some Varroa mite products require the use of a 110 V AC outlet, which is not readily available to outdoor beehives. Another current solution requires most of the beehive to be dismantled to function. In addition, many other products do not include a load cell to measure the health of the colony. No existing product produces a steady-state, surface-temperature controlled heating element or elements for delivering thermal beehive treatment.

As can be seen, there is a need for an improved method and apparatuses for controlling Varroa mite infestation of manmade beehives.

### SUMMARY OF THE INVENTION

In one aspect of the present invention, a manmade beehive includes a thermal unit underneath a bottommost brood box; and an adjustable queen excluder between an uppermost brood box and a honey super box of the manmade beehive, wherein the adjustable queen excluder is movable between a passage position and an exclusion position that prevents passage therethrough of a honeybee colony inhabiting the manmade beehive. As with the adjustable queen excluder, the bottom board beehive entrance provides multiple open and closed conditions, wherein the adjustable queen excluder provides two perforated flat surfaces that are movable relative to each other, wherein the thermal unit has one or more heating elements embedded in a bottom board; and a controller configured to control power to each of the one or more heating elements so that the surface temperature of the heating elements does not exceed 107-degreees F, wherein the controller utilizes direct current, wherein the bottom board further includes one or more load cells and an adjustable entrance that allows for passage and exclusion.

In one aspect of the present invention, a method of improving pest infestation control of a manmade beehive includes placing a bottom board underneath a bottommost brood box of the manmade beehive, wherein the bottom board provides heating elements selectively controlled by a controller; placing a queen excluder between an uppermost brood box and a honey super box, wherein the queen excluder is movable between a passage position and an exclusion position that prevents passage of a worker honeybee through the queen excluder; and setting a constant temperature of approximately 107-°F, by way of the controller, after moving the queen excluder from the passage position to the exclusion position defining a treatment space between the uppermost and bottommost brood boxes in which the worker honeybees are confined.

These and other features, aspects and advantages of the present invention will become better understood with reference to the following drawings, description, and claims.

### BRIEF DESCRIPTION OF THE DRAWINGS

FIG. 1 is an exploded perspective view of an exemplary embodiment of a Varroa mite thermal management system (VTMS+) of the present invention.

FIG. 2 is a side view of an exemplary embodiment of an adjustable queen excluder of the VTMS+.

FIG. 3 is a section view of an exemplary embodiment of a heating element of the present invention, taken along line 3-3 in FIG. 1.

FIG. 4 is a flow chart of implementing an exemplary embodiment of the present invention.

FIG. 5 is an exploded perspective view of an exemplary embodiment of an adjustable queen excluder of the VTMS+.

FIG. 6 is a front view of an exemplary embodiment of an adjustable bottom board entrance of the VTMS+, illustrating an all-open position.

FIG. 7 is a front view of an exemplary embodiment of an adjustable bottom board entrance of the VTMS+, illustrating a reduced, one opening position.

FIG. 8 is a front view of an exemplary embodiment of an adjustable bottom board entrance of the VTMS+, illustrating the fully closed position.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide a system, apparatus, and method for thermal management of Varroa mite infestations in manmade beehives. By using a Varroa mite thermal management system, the present invention controls Varroa mite infestation within the beehive because mites cannot survive above a specific temperature while the honeybees can. The specific temperature is regulated and held constant by a controller. The present invention embodies an adjustable queen excluder and an adjustable bottom board entrance that may be moved between an open condition and a closed condition selectively confining the entire honeybee colony to a control or treatment space subject to the thermal management of the present invention.

In beekeeping, a queen excluder is a selective barrier inside the beehive that allows worker honeybees but not the larger honeybee queens and honeybee drones to traverse the barrier. The intent of the queen excluder is to limit the queen’s access to the honey super boxes. If the queen lays eggs in the honey super boxes and a brood develops in them in situ it is difficult to harvest clean honey. Typically, the queen excluder is either a fixed sheet of perforated metal or plastic or a wire grid. In short, conventional queen excluders enable a substantial portion of the honeybee colony to pass therethrough but do not provide both an exclusion position and a passage position.

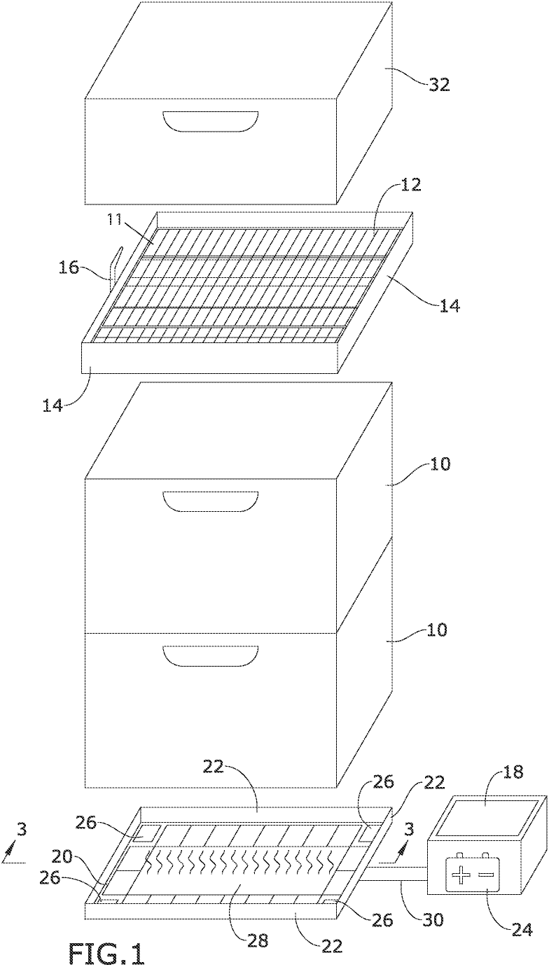

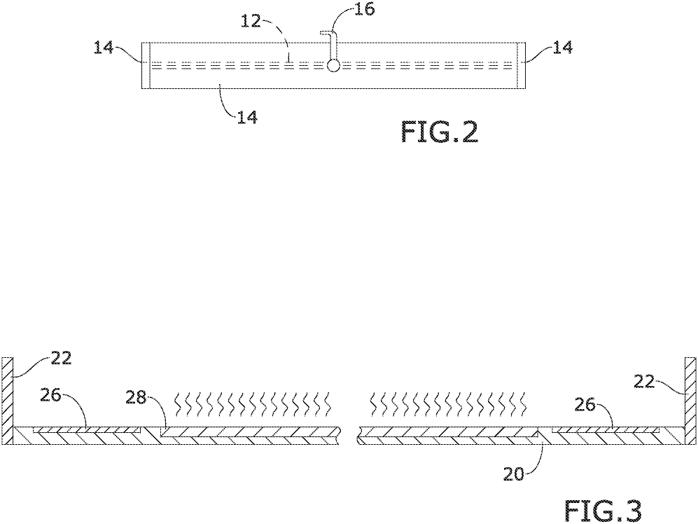

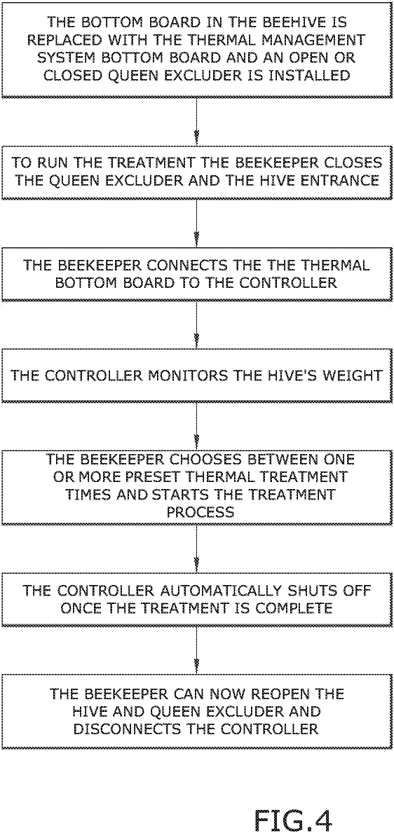

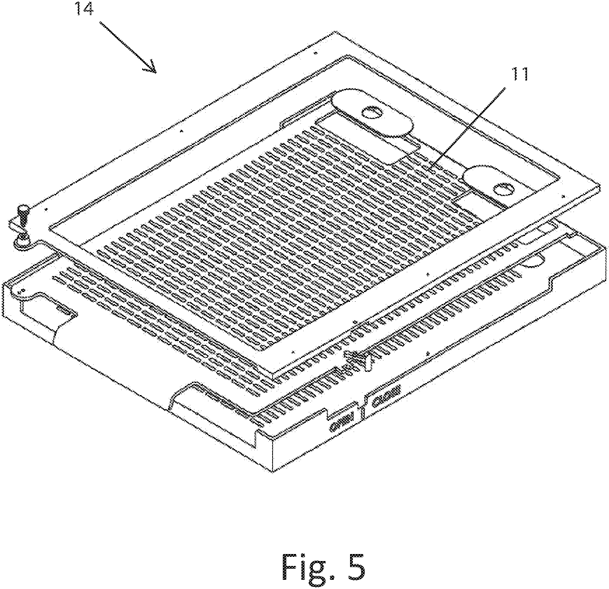

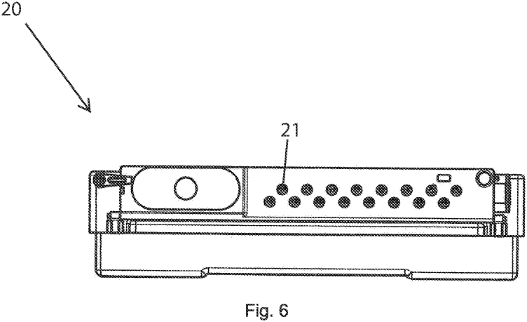

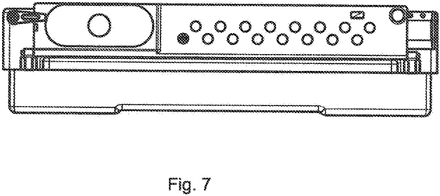

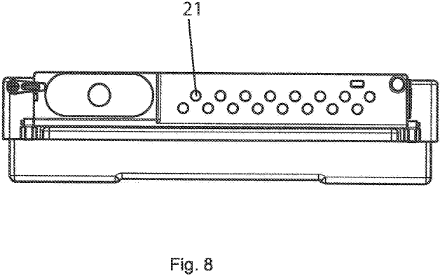

An apparatus for thermal management of Varroa mite infestation in beehives is shown in reference to the drawings of FIGS. 1 – 3. The beehive includes one or more stackable brood boxes 10 that are stacked in a conventional beehive configuration. A Varroa thermal management system (VTMS+) may include an adjustable queen excluder 14 interposed between an upper brood box 10 and a honey super box 32.

The VTMS+ queen excluder 14 may include a pair of overlapping perforated flat sheets/surfaces 12. A lever or handle 16 is operably connected to at least one of the pair of overlapping perforated flat surfaces 12 to selectively position the perforated flat surfaces 12 between an excluding position and a passage position. In the excluding position, the perforated flat sheets 12 are positioned so that the perforations/openings are in an offset alignment, blocking passage therethrough of all honeybees (including the worker honeybees) of the colony between the perforated flat surfaces 12. In the passage position, the perforated flat surfaces 12 are aligned so that the openings/perforations 11 of both sheets 12 align, whereby the openings/perforations 11 permit passage of the smaller worker honeybees (but not the larger honeybee queens and honeybee drones, like a conventional queen excluder). In some embodiments, one dimension of a perforation/opening may be approximately 4.1 millimeters to 4.4 millimeters (between slats defining each perforation in the one said direction).

A systemic bottom board 20 according to aspects of the invention replaces the standard beehive bottom board. The VTMS+ includes a controller 18 to control the surface temperature of the heating elements 28 embedded in the bottom board 20 within the beehive. The VTMS+ may be integrated or retrofitted to a pre-existing manmade beehive. Embodiments may also provide a built-in weight measurement system, which is directly correlated to the health of the colony.

The VTMS+ queen excluder 14 could be used by itself to replace the current queen excluders, as an essential step in the retrofitting of the present invention, as beekeepers can use the systemic queen excluder 14 to block not only the queen and the drones but the entire honeybee colony from the honey super boxes 32 during harvesting.

One or more heating elements may be embedded in the VTMS+ bottom board 20. The heating elements 28 may be flat heaters that are selectively controlled to manage Varroa mite infestations. The bottom board 20 may include load cells 26 or other transducers that determine a weight of the honeybee colony for colony health purposes. A wall assembly 22 may circumscribe the bottom board 20 to make it stackable with adjacent brood box 10.

The VTMS+ controller 18 may utilize a rechargeable, replaceable Lithium or solid-state battery pack 24 to power the VTMS+ bottom board 20 and provide management information to the user.

The controller 18 may be configured to control power to the heating elements 28 so that a specific surface temperature is selectively held constant at approximately 107° F. for the duration of the thermal treatment. Such power control may be achieved by using a set DC voltage, heater resistance, heater watt-density and temperature controller. By attaining a constant surface temperature not exceeding 107° F., the Varroa mites may be exterminated on the honeybees as well as in the brood box honeybee reproductive cells, while the honeybees within the hive are not adversely affected.

The VTMS+ controller 18 may be configured to provide the beekeeper with readouts for weight and remaining time of thermal treatment, along with an auto-shutoff.

The VTMS+ queen excluder 14 is moved to the excluding position before the thermal treatment begins. When in the excluding position, any honeybees remaining in the honey super box 32 can still transition into the thermal treatment brood box through a one-way honeybee entrance. Honeybees tend to return to the brood box every night. This keeps the heat and honeybees inside the thermal treatment brood box(es) 10 of the beehive so that mites carried by all honeybees (queen, drones, and worker bees) as well as emerging Varroa mites in the brood box honeybee reproductive cells may be killed.

In a method according to aspects of the invention, the beekeeper replaces the existing bottom board with the VTMS+ bottom board 20, which includes an adjustable entrance that provides multiple open conditions (defined by one or more openings 21) and a closed condition (closing off the openings 21) preventing any bees of the colony from exiting or entering therethrough. The beekeeper adds the VTMS+ queen excluder 14 between the top brood box 10 and the honey super 32 on the beehive. Once completed, the beekeeper closes manually or remotely the beehive entrance on the VTMS+ bottom board 20 and moves the VTMS+ queen excluder 14 to the exclusion position and connects the VTMS+ controller 18 to one or more beehives.

Once connected, the beekeeper may choose between one or more preset times and starts the treatment. The present invention may incorporate a timer. The VTMS+ controller 18 will automatically shutoff once the treatment is completed. The beekeeper may return or remotely to open the VTMS+ bottom board beehive entrance and move the VTMS+ queen excluder 14 to the passage position.

Now, the beekeeper may disconnect the VTMS+ controller 18 and may continue treatment with the next beehive or beehives.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A manmade beehive comprising:
a thermal unit underneath a bottommost brood box; and
a queen excluder between an uppermost brood box and a honey super box of the manmade beehive, wherein the queen excluder is movable between a passage position and an exclusion position preventing passage through the queen excluder of a worker honeybee inhabiting the manmade beehive, and wherein the passage position enables passage of said worker honeybee through the queen excluder.

2. The manmade beehive of claim 1, wherein the queen excluder comprises of two perforated planar surfaces that are movable relative to each other so that in the passage position a queen honeybee and one or more honeybee drones of a colony are confined to the brood boxes while the worker honeybees of the colony can pass between the honey super box and the uppermost brood box, wherein the exclusion position the colony is confined to the bottommost and uppermost brood boxes and any brood boxes therebetween.

3. The manmade beehive of claim 2, wherein the thermal unit comprises:
one or more heating elements embedded in a bottom board; and
a controller configured to control power to each of the one or more heating elements so that a surface temperature of each heating element is held constant at a temperature not to exceed 107-degreees Fahrenheit.

4. The manmade beehive of claim 3, wherein the controller utilizes direct current.

5. The manmade beehive of claim 4, wherein the direct current is supplied by a removable and rechargeable battery capable of powering a plurality of thermal units in more than one manmade beehive simultaneously.

6. The manmade beehive of claim 4, wherein the bottom board further comprises one or more load cells configured to determine a weight of the colony.

7. The manmade beehive of claim 4, wherein the bottom board further comprises an adjustable beehive entrance that provides multiple open conditions and a closed condition preventing egress of the entire honeybee colony.

8. A method of improving pest infestation control of a manmade beehive, the method comprising:
placing a bottom board underneath a bottommost brood box of the manmade beehive, wherein the bottom board provides heating elements selectively controlled by a controller;
placing a queen excluder between an uppermost brood box and a honey super box, wherein the queen excluder is movable between a passage position and an exclusion position that prevents passage of a worker honeybee through the queen excluder; and
setting a constant temperature of approximately 107-degrees Fahrenheit, by way of the controller, after moving the queen excluder from the passage position to the exclusion position defining a treatment space between the uppermost and bottommost brood boxes in which the worker honeybees are confined.
